(19) United States
(12) Patent Application Publication
(10) Pub. No.: US 2003/0048461 A1
(43) Pub. Date: Mar. 13, 2003

(54) Systems and methods for enhancing the image quality of documents

(76) Inventor: David R. Larson, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/941,819

(22) Filed: Aug. 29, 2001

(51) Int. Cl. G06T 5/00; H04N 1/407; H04N 1/409; H04N 1/58

(52) U.S. Cl. 358/1.9; 382/274; 358/3.27; 358/532

(57) ABSTRACT

Document processing systems for modifying image data are provided. A representative document processing system includes an image enhancement system that is configured to receive image data as well as information corresponding to a request for modification of the image data. In response to the request, the image enhancement system modifies the image data, such as by increasing contrast between the foreground component and the background component and altering lightness of both the foreground component and the background component. Methods and other systems also are provided.

### BACKGROUND OF THE INVENTION

1. Field of the Invention

The present invention relates to computers. More specifically, the invention relates to systems and methods for enhancing the image quality of documents by enabling modification of image data associated with such documents.

2. Description of the Related Art

Document-processing devices, such as copiers, scanners and multi-function devices, are capable of acquiring image data corresponding to documents. After acquiring the image data, such document-processing devices enable the image data to be used for producing copies of the documents.

As is known, a copy of a document produced by a document-processing device may not possess a level of image quality desired by a user. For instance, the copy may not exhibit a desired contrast between the foreground, e.g., printed text, and the background, i.e., the print medium. Additionally, both the foreground and the background of the copy may be too light or dark.

Conventional document-processing devices typically provide a user with one of two types of functionality for enabling the user to modify the image quality of a copy. In particular, document-processing devices typically provide either the ability to adjust only the overall lightness of a copy or the ability to adjust separately the contrast and lightness of the copy. Each of these types of functionality, however, have perceived limitations. More specifically, when providing a user only with the ability to adjust the overall lightness of a copy, a user may be unable to obtain a copy exhibiting the desired image quality. Alternatively, when providing a user with the ability to adjust separately the contrast and lightness of the copy, the user may have difficulty understanding the relationship between contrast and lightness adjustments and, therefore, may be unable to achieve the desired image quality in an efficient manner.

### SUMMARY OF THE INVENTION

Briefly described, the present invention involves enhancing the image quality of documents by enabling modification of image data associated with such documents. In this regard, a representative document processing system of the invention includes an image enhancement system for modifying image data. Preferably, the image enhancement system is configured to receive image data and information corresponding to a request for modification of the image data. In response to the request, the image enhancement system modifies the image data, such as by increasing contrast between the foreground component and the background component and altering lightness of both the foreground component and the background component.

A representative method for modifying image data includes: receiving image data; receiving information corresponding to a request for modification of the image data; and in response to the request, modifying the image data by increasing contrast between the foreground component and the background component and altering lightness of both the foreground component and background component.

Other features and advantages of the present invention will become apparent to one with skill in the art upon examination of the following drawings and detailed description. It is intended that all such features and advantages be included herein within the scope of the present invention, as defined in the appended claims.

### BRIEF DESCRIPTION OF THE SEVERAL VIEWS OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting a representative embodiment of the document-processing system of the present invention.

FIG. 2 is a flowchart depicting representative functionality of the document-processing system of FIG. 1.

FIG. 3 is a schematic diagram depicting a computer or processor-based device that may be utilized to implement the image enhancement system of FIG. 1.

FIG. 4 is a flowchart depicting representative functionality of the image enhancement system of FIG. 3.

FIG. 5 is a schematic diagram depicting a representative embodiment of a graphical user interface that may be utilized to implement the image enhancement system of FIG. 3.

FIG. 6 is a flowchart depicting representative functionality of the image enhancement system of FIG. 3.

### DETAILED DESCRIPTION

As described in greater detail herein, the present invention involves enhancing the image quality of documents. In this regard, various embodiments of the invention are able to enhance the image quality of documents by enabling modification of image data associated with the documents. More specifically, image data corresponding to a document can be modified in response to a user actuating a single actuator, e.g., a button or other mechanically actuated component, of a device or user interface. Depending upon the particular input provided via the actuator, the input can be interpreted as a request for a change in contrast and overall lightness of a copy of the document. In this manner, embodiments of the invention potentially provide a user with improved functionality compared to document-processing devices of the prior art. More specifically, these devices of the prior art are known to provide a user with either the ability to adjust only the overall lightness of a copy, or the ability to adjust separately the contrast and lightness of the copy, such as with separate contrast and lightness adjustment actuators.

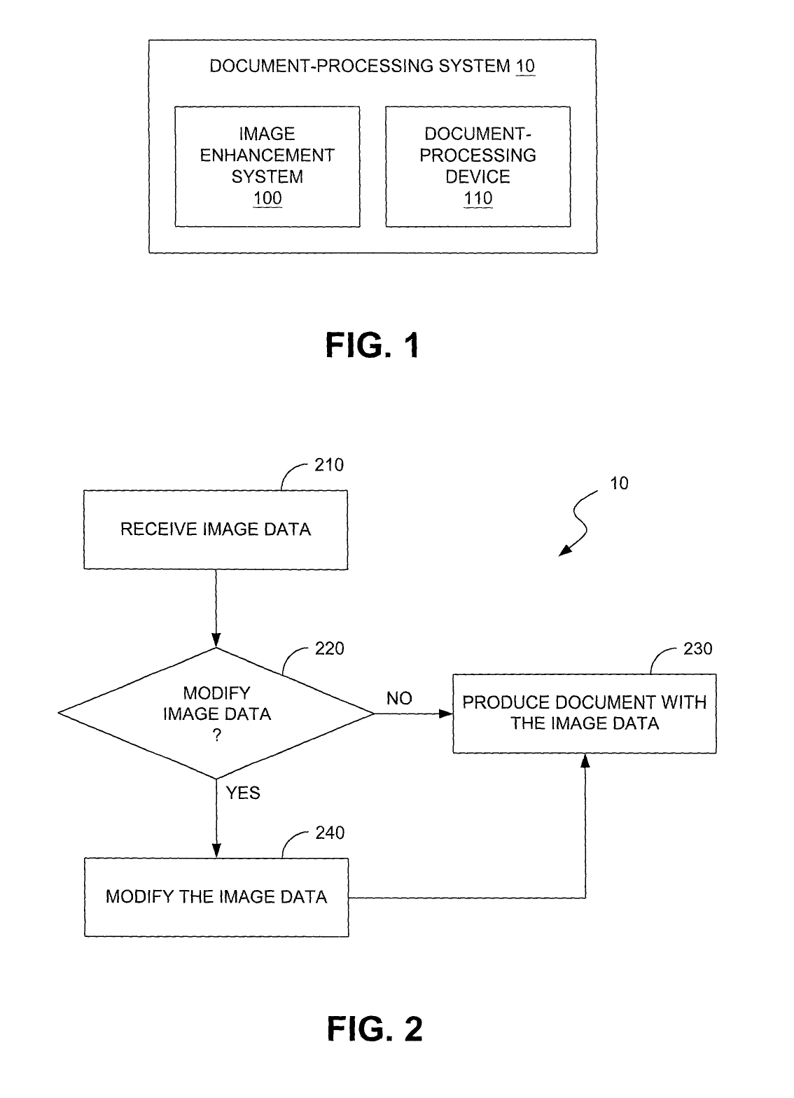

Referring now to the figures, wherein like reference numerals indicate corresponding components throughout the several views, FIG. 1 depicts a representative embodiment of a document-processing system 10 of the invention. As shown in FIG. 1, document-processing system 10 includes an image enhancement system 100 and a document-processing device 110. For instance, document-processing device 110 can be a copier, printer, scanner, multi-function device or any other device or combination of devices that is capable of producing a likeness or copy of a document. As used herein, the term “multi-function device” refers to a device that is capable of performing more than one of copying, faxing, scanning and printing. The term “document” is used herein to denote a medium that includes an image, e.g., text, photograph, etc.

Representative functionality of the document-processing system 10 is depicted in the flowchart of FIG. 2. As shown in FIG. 2, functionality of the document-processing system 10 may be construed as beginning at block 210, where image data is received. In block 220, a determination is made as to whether the image data is to be modified. For instance, a user may have produced a copy of a document using a document-processing device of the document-processing system and subsequently determined that the copy does not exhibit a desired image quality. Thus, the determination regarding whether the image data is to be modified (block 220) may be made in response to a user input, i.e., a user input corresponding to a request for modifying the image data. In other embodiments, a user may provide an input corresponding to a request for modifying image data prior to the document-processing system receiving the image data. This may occur when the document to be copied does not exhibit the desired image quality and the user intends to alter the image quality by using the document-processing system.

If it is determined (in block 220) that the image data does not require modification, the process may proceed to block 230 where a document, i.e., a copy, can be produced. If, however, it is determined that modification of the image data is required/desired, the process may proceed to block 240 where the image data is modified (described in detail hereinafter). After modification, the process may proceed to block 230 where the modified image data may be used to produce a copy. Note, in some embodiments, the functionality depicted in blocks 210, 220 and 240 generally may be attributed to the image enhancement system.

Image enhancement system 100 can be implemented in software, firmware, hardware, or a combination thereof. Preferably, when implemented by a document-processing device, the image enhancement system 100 is provided as firmware. When implemented in hardware, however, image enhancement system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

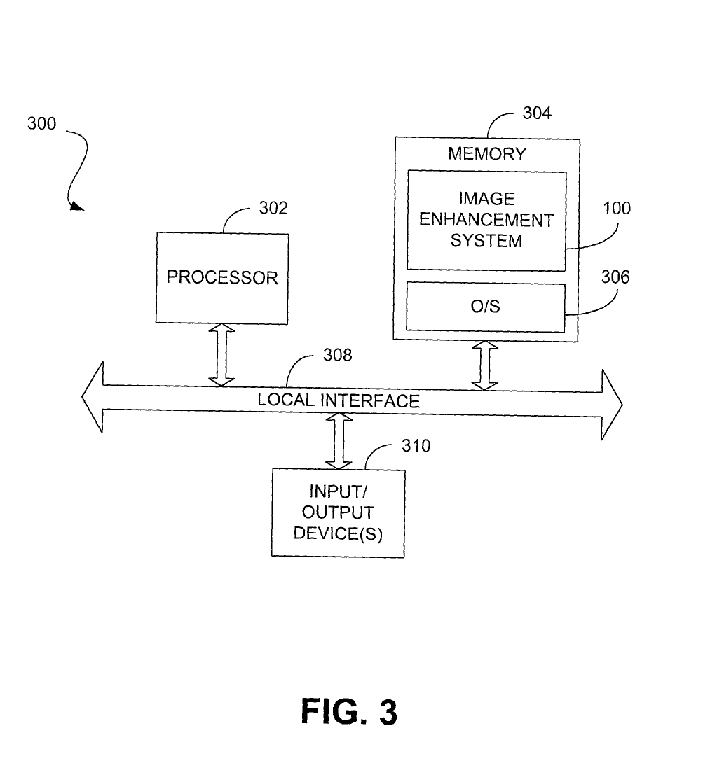

When implemented in software, image enhancement system 100 can be a program that is executable by a digital computer, e.g., a computer implemented as or associated with a document-processing device. An example of a computer that can employ image enhancement system 100 as a software implementation is shown schematically in FIG. 3.

Generally, in terms of hardware architecture, computer 300 of FIG. 3 includes a processor 302, memory 304, and one or more input and/or output (I/O) devices 306 (or peripherals) that are communicatively coupled via a local interface 308. Local interface 308 can be, for example, one or more buses or other wired or wireless connections, as is known in the art. Local interface 308 can include additional elements, which are omitted for ease of description. These additional elements can be controllers, buffers (caches), and/or drivers, for example. Further, the local interface may include address, control, and/or data connections to enable appropriate communications among the components of computer 300.

Processor 302 can be a hardware device configured to execute software that can be stored in memory 304. Processor 302 can be any custom made or commercially available processor, a central processing unit (CPU) or an auxiliary processor among several processors associated with the computer 300. Additionally, the processor can be a semiconductor-based microprocessor (in the form of a microchip), for example.

Memory 304 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 304 can incorporate electronic, magnetic, optical, and/or other types of storage media. Note that memory 304 can have a distributed architecture, where various components are situated remote from one another, but can be accessed by processor 302.

The software in memory 304 can include one or more separate programs, each of which comprises an ordered listing of executable instructions for implementing logical functions. The software in the memory 304 includes image enhancement system 100 and a suitable operating system (O/S) 310. The operating system 310 controls the execution of other computer programs, such as image enhancement system 100. Operating system 310 also provides scheduling, input-output control, file and data management, memory management, and communication control and related services.

The I/O device(s) 306 can include input devices such as a keypad, for example. I/O device(s) 306 also can include output devices such as a display device, speaker or printing device, for example. I/O device(s) 306 may further include devices that are configured to communicate both inputs and outputs such as a touch screen display or USB port, for example.

When the computer 300 is in operation, processor 302 is configured to execute software stored within the memory 304, communicate data to and from the memory 304, and generally control operations of the computer 300. Image enhancement system 100 and the O/S 310, in whole or in part, are read by the processor 302, perhaps buffered within processor 302, and then executed.

When image enhancement system 100 is implemented in software, it should be noted that the image enhancement system can be stored on any computer readable medium for use by or in connection with any computer-related system or method. In the context of this document, a computer-readable medium is an electronic, magnetic, optical, or other physical device or means that can contain or store a computer program for use by or in connection with a computer-related system or method. Image enhancement system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

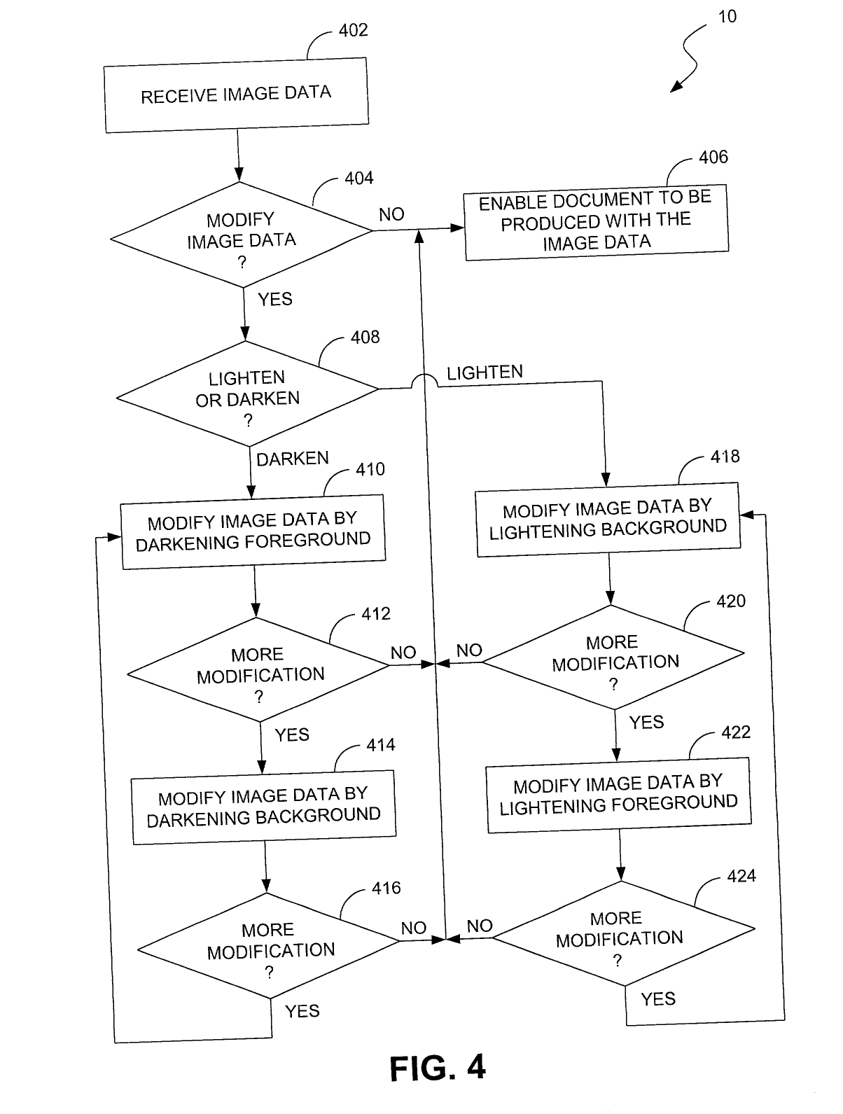

Reference will now be made to the flowchart of FIG. 4, which depicts the functionality of a representative embodiment of image enhancement system 100. In this regard, each block of the flowchart represents a module segment, portion of code or logic circuit(s) for implementing the specified logical function(s). It should also be noted that in some alternative implementations the functions noted in various blocks of FIG. 4, or any other of the accompanying flowcharts, may occur out of the order in which they are depicted. For example, two blocks shown in succession in FIG. 4 may, in fact, be executed substantially concurrently. In other embodiments, the blocks may sometimes be executed in the reverse order depending upon the functionality involved.

As shown in FIG. 4, the functionality of the representative embodiment of the image enhancement system or method 100 may be construed as beginning at block 402 where image data corresponding to a document is received. In block 404, a determination is made as to whether the image data is to be modified. If the image data is not to be modified, the process may proceed to block 406 where production of a copy of the document using the image data is enabled. If, however, the image data is to be modified, the process may proceed to block 408.

In block 408, a determination may be made as to whether a copy corresponding to the image data is to be made “lighter” or “darker.” In this context, the terms “lighter” and “darker” each can refer to changing the contrast and/or overall lightness of a copy. For instance, if it is determined that the copy is to be made “darker,” the process may proceed to block 410 where the image data can be modified by darkening components of the image data attributed to the foreground. This and some other embodiments of the image enhancement system first decrease the lightness (or darken) the foreground components in response to a request for a “darker” copy. This is because users typically want an increase in contrast between the foreground and background components of a document when they express a desire for a darker copy. In particular, such a user typically wants the lightness of the foreground components decreased and the lightness of the background components to remain unchanged. In these embodiments, it can be assumed that the components of the image data attributable to the foreground are darker than those components of the image data attributable to the background. This assumption is consistent with a light print medium, e.g., white paper, and dark print, e.g., text. However, image enhancement systems operating on other assumptions, e.g., the background components are darker than the foreground components, also can be used.

After darkening the foreground components, another determination may be made as to whether the copy corresponding to the image data is to be made “darker” (block 412). If it is determined that the copy still needs to be “daker,” the process may proceed to block 414 where the image data can be modified by darkening components of the image data attributable to the background. Thus, by darkening the foreground and the background, a change in the overall lightness of the copy is achieved, i.e., the entire copy has been made darker. This typically is consistent with a user's desire for a darker copy once one or more changes have been made to the contrast between background and foreground components.

In some embodiments, such as the embodiment depicted in FIG. 4, if the image data still requires darkening after being modified in blocks 410 and 414 (see block 416), the process may return to block 410 and proceed as described before. More specifically, the process may continue to incrementally increase contrast and apply a change to the overall lightness. In other embodiments, both the foreground and background components can be darkened simultaneously. Clearly, in other embodiments, either or both of the foreground and background components could be modified by darkening in various combinations as desired.

Once it is determined that the copy corresponding to the image data no longer needs to be “darker,” the process may proceed to block 406 where production of the copy with the modified image data is enabled. Such would be the case when a negative determination is made in regard to blocks 412 and 416, for instance.

Referring once again to block 408, if it is determined that the copy is to be made “lighter,” the process may proceed to block 418 where the image data can be modified by increasing the lightness of components of the image data attributable to the background. This and some other embodiments of the image enhancement system first lighten the background components in response to a request for a “lighter” copy, because users typically want an increase in contrast between the foreground and background components of a document when they express a desire for a “lighter” copy. For instance, such a user typically wants the lightness of the background components increased and the lightness of the foreground components to remain unchanged.

In block 420, another determination may be made as to whether the copy corresponding to the image data is to be made “lighter.” If it is determined that the copy still needs to be “lighter,” the process may proceed to block 422 where the image data can be modified by lightening components of the image data attributable to the foreground. Thus, by lightening the foreground and the background, a change in the overall lightness of the copy is achieved, i.e., the entire copy has been made lighter. This typically is consistent with a user's desire for a lighter copy once one or more changes have been made to the contrast between background and foreground components.

In some embodiments, such as the embodiment depicted in FIG. 4, if the image data still requires lightening after being modified in blocks 418 and 422 (see block 424), the process may return to block 418 and proceed as described before. More specifically, the process may continue to incrementally increase contrast and apply a change to the overall lightness. In other embodiments, both the foreground and background components can be lightened simultaneously. Clearly, in other embodiments, either or both of the foreground and background components could be modified by lightening in various combinations as desired.

Once it is determined that the copy corresponding to the image data no longer needs to be “lighter,” the process may proceed to block 406 where production of the copy with the modified image data is enabled. Such would be the case when a negative determination is made in regard to blocks 420 and 424, for instance.

By using the image enhancement system (or method) 100, a document-processing device can potentially exhibit improved performance compared to a similar device that does not incorporate such a system. In particular, the user may not have to understand the relationship between contrast and lightness adjustments in order to achieve the desired image quality of a copy. Since embodiments of the image enhancement system are capable of modifying image data based on various assumptions regarding a user's desire to modify image data, a user's efficiency in obtaining a properly modified copy can be increased. As mentioned before, this typically is accomplished by enabling image data corresponding to a document to be modified in response to a user actuating a single actuator of a document-processing device or user interface.

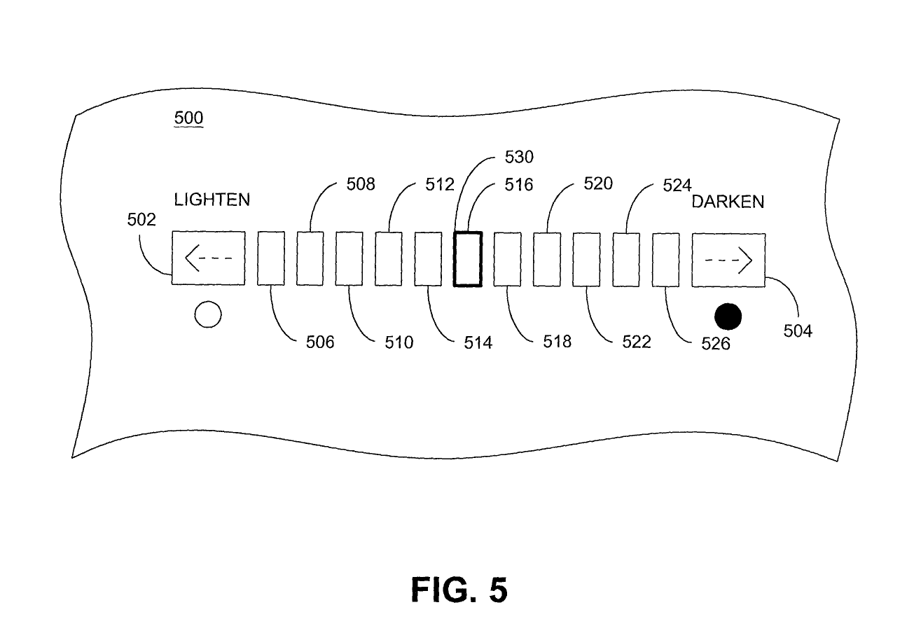

A representative example of a portion of a graphical user interface 500 that can be used to provide user input to an image enhancement system is depicted in FIG. 5. As shown in FIG. 5, user interface 500 provides a “lighten” actuator 502, a “darken” actuator 504 and a series of indicators 506-526. Indicators 506-526 are used to depict the degree of lightening/darkening to be used for modifying image data. For example, a nominal setting is associated with indicator 516. Indicator 516 also corresponds to the current location of the current setting indicator 530, which is depicted in FIG. 5 as a highlighted periphery of the indicator.

A user can utilize user interface 500 by actuating one of the actuators 502,504 (placing one of the actuators in an actuated state) in a conventional manner to reposition the current setting indicator. By so doing, the image processing system can modify image data in a manner corresponding to the ultimate position of the current setting indicator 530. Table 1 depicts representative correlation between several positions of current setting indicator 530 and possible modifications to be made to the associated image data when the image data is grayscale image data.

TABLE 1

| | | White | | |
|---|---|---|---|---|
| | Current Setting | Clip | Black Clip | Modification |
| Lighter 2 | Indicator 512 | 125 | 75 | Overall Lightening |
| Lighter 1 | Indicator 514 | 125 | 100 | Contrast Change |
| Nominal | Indicator 516 | 150 | 100 | None |
| Darker 1 | Indicator 518 | 150 | 125 | Contrast Change |
| Darker 2 | Indicator 520 | 175 | 125 | Overall Darkening |

In Table 1., “White Clip” refers to that value of a pixel at or above which the pixel will be considered “white,” and “Black Clip” refers to that value of a pixel at or below which the pixel will be considered “black.” Note, a pixel can have a value of between 0 (black) and 255 (white). Therefore, if a pixel has a value of 125 with the current setting at “Nominal,” represented by indicator 516, the pixel retains its value. If, however, the current setting was changed to “Lighter 1, ” represented by indicator 514 (FIG. 5), the pixel would be modified to white. Thus, the aforementioned pixel would be lightened.

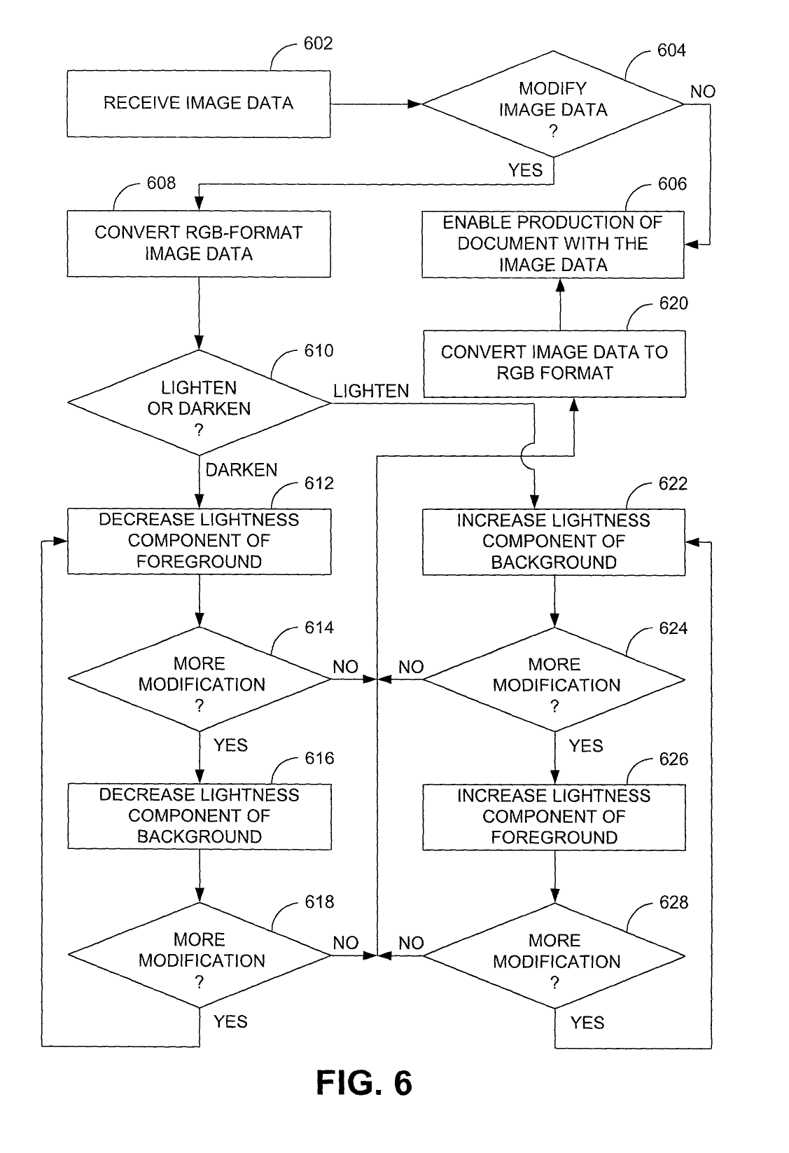

Alternative functionality of the image enhancement system 100 will be described with reference to the flowchart of FIG. 6. As will be described hereinafter, such an embodiment may be capable of making a copy “lighter” or “darker” without changing the color of an image. More specifically, color information may be contained in the image data, e.g., data configured as RGB triplets, that is associated with either or both of the background and foreground components of a document. In some embodiments, this color information may be maintained while adjustments are made to the lightness of the image data. This is in contrast to embodiments of the image enhancement system that may only be adapted to adequately receive and/or modify grayscale image data, such as described before herein.

Referring now to FIG. 6, the image enhancement system (or method) 100 depicted therein may be construed as beginning at block 602 where image data corresponding to a document is received. In block 604, a determination is made as to whether the image data is to be modified. If the image data is not to be modified, the process may proceed to block 606 where a copy of the document is enabled to be produced using the image data. If, however, the image data is to be modified, the process may proceed to block 608.

In block 608, the image data, which may be in RGB format, may be converted to Lightness Hue Chroma (LHC) or Lightness a b (LAB) data, for example. This conversion is done to separate the color information from the lightness/darkness information. Note, LHC and LAB are recited herein because they are standard color-space representations with known conversions from RGB; however, various other color-space representations could be used.

Proceeding to block 610, a determination may be made as to whether a copy corresponding to the image data is to be made “lighter” or “darker.” If it is determined that the copy is to be made “darker,” the process may proceed to block 612 where the image data can be modified by darkening the lightness parameter of the image data attributed to the foreground. In these embodiments, it can be assumed that the components of the image data attributable to the foreground are darker than those components of the image data attributable to the background. This assumption is consistent with a light-colored print medium and dark-colored print. However, image enhancement systems operating on other assumptions, e.g., the background components are darker than the foreground components, also can be used.

After darkening the foreground components, another determination may be made as to whether the copy corresponding to the image data is to be made “darker” (block 614). If it is determined that the copy still needs to be “darker,” the process may proceed to block 616 where the image data can be modified by darkening the lightness parameter of components of the image data attributable to the background. Thus, by darkening the lightness parameters of the foreground and the background, a change in the overall lightness of the copy is achieved, i.e., the entire copy is made darker, while maintaining the color.

In some embodiments, such as the embodiment depicted in FIG. 6, if the image data still requires modification after being modified in blocks 612 and 616 (see block 618), the process may return to block 612 and proceed as described before. More specifically, the process may continue to incrementally increase contrast and apply a change to the overall lightness. In other embodiments, both the foreground and background components can be darkened simultaneously. Clearly, in other embodiments, either or both of the foreground and background components could be modified by darkening in various combinations as desired.

Once it is determined that the copy corresponding to the image data no longer needs to be “darker,” the process may proceed to block 620 where the image data is converted back to RGB format. Thereafter, the process may proceed to block 606 where the copy is enabled to be produced with the modified image data.

Referring once again to block 608, if it is determined that the copy is to be made “lighter,” the process may proceed to block 622 where the image data can be modified by lightening the lightness parameter of components of the image data attributable to the background. In block 624, another determination may be made as to whether the copy corresponding to the image data is to be made “lighter.” If it is determined that the copy still needs to be “lighter,” the process may proceed to block 626 where the image data can be modified by lightening the lightness parameter of components of the image data attributable to the foreground. Thus, by lightening the lightness parameters of the foreground and the background, a change in the overall lightness of the copy is achieved, i.e., the entire copy is made lighter, while maintaining the color.

In some embodiments, such as the embodiment depicted in FIG. 6, if the image data still requires modification after being modified in blocks 622 and 626 (see block 628), the process may return to block 622 and proceed as described before. More specifically, the process may continue to incrementally increase contrast and apply a change to the overall lightness. In other embodiments, both the foreground and background components can be lightened simultaneously. Clearly, in other embodiments, either or both of the foreground and background components could be modified by lightening in various combinations as desired.

Once it is determined that the copy corresponding to the image data no longer needs to be “lighter,” the process may proceed to block 620 where the image data is converted back to RGB format. Thereafter, the process may proceed to block 606 where the copy is enabled to be produced with the modified image data.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated.

By way of example, image enhancement systems operating on the assumption that foreground components are darker than background components can be used to enhance image data of a document to be copied where the foreground components of the document are lighter than the background components. In such embodiments, making the image data “lighter” from the nominal setting could increase the lightness of the foreground will maintaining the lightness of the background. Therefore, a change in contrast between foreground and background is achieved. Thereafter, another attempt to “lighten” the data could increase the lightness of the background, thereby changing the overall lightness of the image data.

As another example, some embodiments of the image enhancement system may be configured to determine whether received image data contains color information, e.g., RGB format pixel data. Based upon that determination, such a system may convert the image data into another format. For instance, the system may convert the image data to LHC data. However, if it is determined that the image data only contains grayscale image data, the system may proceed to modify the image data, as desired, without converting the image data into another format.

All such modifications and variations, are within the scope of the invention as determined by the appended claims when interpreted in accordance with the breadth to which they are fairly and legally entitled.

1. A document processing system for modifying image data, the image data including a foreground component and a background component, said document processing system comprising:
an image enhancement system configured to receive image data, receive information corresponding to a request for modification of the image data, and, in response to the request, modify the image data by increasing contrast between the foreground component and the background component and altering lightness of both the foreground component and the background component.

2. The document processing system of claim 1, further comprising:
an actuator communicating with said image enhancement system, said actuator having an actuated state corresponding to the request for modification of the image data.

3. The document processing system of claim 2, wherein said actuator is implemented via a graphical user interface.

4. The document processing system of claim 3, further comprising:
a document processing device communicating with said image enhancement system, said document processing device being configured to produce a document with the image data, said document processing device including said actuator.

5. The document processing system of claim 4, wherein said document processing device is selected from the group consisting of: a copier, a scanner, a printer, and a multi-function device.

6. The document processing system of claim 1, wherein said image enhancement system is configured to modify the image data incrementally, such that, at a first increment, the image data is modified by increasing contrast between the foreground component and the background component.

7. The document processing system of claim 6, at said first increment, lightness of only one of the foreground component and the background component is increased.

8. The document processing system of claim 6, wherein, at said first increment, lightness of only one of the foreground component and the background component is decreased.

9. The document processing system of claim 6, wherein, at said first increment, lightness of only one of the foreground component and the background component is altered, and at a second increment, the image data is modified by altering lightness of the other of the foreground component and background component such that overall lightness of the image data is altered.

10. The document processing system of claim 1, wherein said image enhancement system is configured to separate the image data into a color component and a lightness component and modify only the lightness component of the image data.

11. The document processing system of claim 10, wherein said image enhancement system is configured to receive the image data in RGB format, convert the image data to one of Lightness Hue Chroma and Lightness a b format, and convert the image data to RGB format after modification.

12. The document processing system of claim 10, further comprising:
means for producing a document with the image data.

13. A method for modifying image data, the image data including a foreground component and a background component, said method comprising:
receiving image data;
receiving information corresponding to a request for modification of the image data; and
in response to the request, modifying the image data by increasing contrast between the foreground component and the background component and altering lightness of both the foreground component and background component.

14. The method of claim 13, further comprising:
providing a graphical user interface; and
wherein the request for modification of the image data is facilitated via the graphical user interface.

15. The method of claim 13, further comprising:
producing a document with the image data.

16. The method of claim 13, wherein modifying the image data includes modifying the image data incrementally, such that, at a first increment, the image data is modified by increasing contrast between the foreground component and the background component.

17. The method of claim 16, wherein, at the first increment, lightness of only one of the foreground component and the background component is increased.

18. The method of claim 16, wherein, at the first increment, lightness of only one of the foreground component and the background component is decreased.

19. The method of claim 13, wherein modifying the image data incrementally includes:
altering lightness of only one of the foreground component and the background component at the first increment; and
altering lightness of the other of the foreground component and background component at a second increment such that overall lightness of the image data is altered.

20. The method of claim 13, wherein modifying the image data includes:
separating the image data into a color component and a lightness component; and
modifying only the lightness component of the image data.
